(19) United States
(12) Patent Application Publication
(10) Pub. No.: US 2010/0035492 A1
(43) Pub. Date: Feb. 11, 2010

(54) FUNCTIONALISATION METHOD OF A TEXTILE SUBSTRATE BY BRIDGING UNDER AN IONISING RADIATION

(75) Inventor: Claudine Colin, Charly (FR)

Correspondence Address: BACHMAN & LAPOINTE, P.C., 900 CHAPEL STREET, SUITE 1201, NEW HAVEN, CT, 06510, US

(73) Assignee: LAINIERE DE PICARDIE, Peronne Cedex (FR)

(21) Appl. No.: 12/522,586

(22) PCT Filed: Jan. 9, 2008
(86) PCT No.: PCT/FR08/00025

§ 371 Date: Aug. 25, 2009

(30) Foreign Application Priority Data
Jan. 10, 2007 (FR) 0700164

(51) Int. Cl. B32B 5/02; B05D 3/06; B32B 5/26

(52) U.S. Cl. 442/59; 427/523; 427/525; 442/255; 442/304

(57) ABSTRACT

A method for functionalising a textile substrate using an active composition is described. The method includes the following steps: preparing a formulation of microcapsules containing the active composition in an envelope, the envelope being based on a material containing a type of group reacting under an ionising radiation, and the formulation further comprising at least one cross-linking bonding agent having two types of groups reacting under an ionising radiation; impregnating the textile substrate with the microcapsule formulation; applying an ionising radiation to the impregnated textile substrate in order to carry out the cross-linking bonding of the microcapsules on the substrate by reaction of the reactive groups. A functionalised textile substrate obtained by the method, and a textile item made from such textile substrate are described.

### BACKGROUND

(1) Field of the Invention

The invention relates to a functionalisation method of a textile substrate by means of an active composition, a textile substrate functionalised using such a method, and a textile article fashioned with such a textile substrate.

The invention particularly applies to the functionalisation of textile substrates so as to give same heat regulation properties. For this purpose, it is known to fix microcapsules incorporating a phase change material composition with the textile substrate. Indeed, by means of the absorption—restitution of heat energy during phase changes of the material, the textile substrate makes it possible to delay temperature changes so as to provide thermal comfort.

(2) Prior Art

In order to fix the microcapsules on the textile substrate, the coating of a polymer binder layer wherein the microcapsules are dispersed, said binder adhering on said textile substrate, is known, particularly from document EP-0 0611 330.

However, due to the presence of the binder layer, this solution does not give full satisfaction in terms of the flexibility of the textile substrate. In addition, the weight of the coated textile substrate is increased detrimentally. Finally, as the binder layer is air-tight, the breathability of the textile substrate is also deteriorated. All these limitations mean that it is not possible to fashion, with the textile substrate, a suitable textile article, particularly to be worn close to a person's body.

Moreover, an individual microcapsule fixing method on the textile substrate is known from the document EP-1 275 769. For this purpose, the microcapsules are dispersed with a fixing agent and the textile substrate is impregnated with said dispersion. UV radiation is then applied to activate the fixing agent so as to ensure the individual fixing of the microcapsules on the textile substrate.

This method, while it addresses the problems of the method explained above, is limited with respect to the quantity of microcapsules that can be fixed.

### SUMMARY OF THE INVENTION

The aim of the invention is to remedy the drawbacks of the prior art by proposing a functionalisation method of a textile substrate wherein a large quantity of an active composition can be incorporated, without limiting the flexibility and breathability of said textile substrate significantly.

To this end, according to a first embodiment, the invention proposes a functionalisation method of a textile substrate by means of an active composition, said method comprising steps consisting of:

preparing a microcapsule formulation containing the active composition in an envelope, said envelope being based on a material comprising a type of reactive group upon an ionising radiation, said formulation also comprising at least one bridging agent having two types of reactive groups upon an ionising radiation;

impregnating the textile substrate with the microcapsule formulation;

applying ionising radiation on the impregnated textile substrate so as to bridge the microcapsules on said substrate by reacting the reactive groups.

According to a second embodiment, the invention proposes a textile substrate functionalised using such a method, said substrate incorporating more than 10 g/m² microcapsules containing the active composition, said microcapsules being associated by means of bridging between the envelope thereof and the fibres of said substrate.

According to the third embodiment, the invention proposes a textile article fashioned with such a textile substrate, said article also comprising, on one side of the textile substrate, an inner textile layer and, on the other side of said substrate, an outer textile layer which is arranged to capture an air volume.

Other specificities and advantages of the invention will emerge in the description hereinafter of various specific embodiments.

### DETAILED DESCRIPTION OF THE PREFERRED EMBODIMENT(S)

The invention relates to a functionalisation method of a textile substrate by means of an active composition. In particular, the active substance may be capable of giving the textile substrate a heat regulation function. In other applications, the active substance may have other functions, for example hygienic or comfort-related. In examples of embodiments, the active substance may comprise essential oils, particularly to improve breathing, fragrances, repellents, particularly against mosquitoes, conductive or antistatic charges, bacteriostatic agents such as silver salts, anti-odour agents.

The method envisages preparing a microcapsule formulation containing the active composition in an envelope, said microcapsules being less than 20 μm in size, particularly between 1 and 10 μm on average.

In the formulation described below, the active substance comprises a phase change material wherein the melting point is between 15° C. and 38° C., preferentially between 22° C. and 35° C., so as to ensure heat regulation in the vicinity of human body temperature.

Using a known method, such a composition may be based on paraffin, particularly comprising between 16 and 22 carbon atoms according to the desired melting point. In this way, when the ambient temperature increases, the liquefaction of the composition enables absorption of heat energy at quasi-constant temperature and, when the ambient temperature decreases, the solidification of said composition restores said heat energy. In an alternative embodiment, it is possible to use fire-proof phase change materials not containing paraffins, particularly for non-fire applications.

In addition, the microcapsule envelope is based on a material comprising a reactive group type upon an ionising radiation. In particular, such groups may comprise an unsaturated bond which, under the effect of ionising radiation, forms a reactive free radical. In examples of embodiments, the reactive groups upon an ionising radiation are selected in the group comprising hydroxyl, carboxyl, carbonyl, acrylate, methacrylate, amine, amide, imide, urethane, styrene groups. In an alternative embodiment, the envelope may comprise several types of reactive groups upon an ionising radiation.

The formulation described comprises two types of microcapsules, the phase change materials of each of the types of microcapsules differing by the melting point thereof. In particular, both types of microcapsules may be those referenced Lurapret TX PMC 28 and Lurapret TX PMC 35 produced by BASF, which have a melting point of 28° C. and 35° C., respectively. For this purpose, the phase change material is n-Octodecane and n-Eicosane, respectively, the calorie storage or restitution capacity being of the order of 170 J/g. Furthermore, the envelope of said microcapsules is based on polymethylmethacrylate (PMMA) which comprises reactive acrylate groups upon an ionising radiation.

The microcapsule formulation also comprises at least one bridging agent having two types of reactive groups upon an ionising radiation, said types optionally being identical or different. As for the envelope, the reactive groups upon an ionising radiation may be selected in the group comprising hydroxyl, carboxyl, carbonyl, acrylate, methacrylate, amine, amide, imide, urethane, styrene groups. In addition, at least some reactive groups may be selected to be thermally reactive.

More specifically, the microcapsule formulation may comprise a mixture of bridging agents, particularly selected in the group comprising glycidyl acrylate or methacrylate (AGLY, MAGLY), polyethylene glycol 200, 400, 600 diacrylates (PEG200 DA, PEG400 DA, PEG600 DA), dipropylene glycol diacrylate (DPGDA), potassium sulphopropyl methacrylate (SPMK) and lauryl methacrylate or acrylate.

In particular, AGLY or MAGLY is a bifunctional bridging agent having an epoxy group and acrylate or methacrylate group and PEG DAs are bifunctional internal plasticising agents which contribute to bridge by extending the bond chains between the microcapsules and the fibres. Therefore, the combined use of both types of bridging agents makes it possible to enhance the flexibility of the microcapsule deposition.

The mass ratio between the bridging agent(s) and the microcapsules is preferentially less than 0.5, particularly between 0.10 and 0.30.

Moreover, the microcapsule formulation may comprise between 30% and 60% by weight, particularly between 40% and 50% by weight, microcapsules dispersed in a solvent, particularly in water. The microcapsule formulation may also comprise at least one agent enhancing the stability of the dispersion, for example sulphopropyl methacrylate (SPM) or sulphopropyl acrylate (SPA) which are anionic monomers reactive upon an ionising radiation, or an acrylic latex such as that sold under the brand name HYCAR 26319 which enhances the wetting of the microcapsules by the bridging agents while creating bridges between the microcapsules and the substrate. In an alternative embodiment, said agent may be a polyacrylate in gel form or a polyurethane dispersion.

The method then envisages impregnating the textile substrate with the microcapsule formulation. The impregnation may be performed by means of padding, the conditions of said padding and the features of the textile substrate being adapted to lift at least 80% and preferentially at 150% by weight of microcapsule formulation in said textile substrate. In this way, by combining a formulation with very high microcapsule content and a high lift rate, it is possible, by means of the different reactive groups, to fix a large quantity of microcapsules in the textile substrate.

In particular, the microcapsule formulation may be thixotropic and the viscosity thereof between 130 and 150 mPa·s, particularly by adding a liquefier to said formulation, such as isopropanol. In addition, a textile substrate may be based on hydrophilic fibres. In this way, it is possible to obtain good wetting and a satisfactory rise of the formulation in the textile substrate during impregnation.

Moreover, the calendaring pressure during padding is relatively low, particularly of the order of 1 to 2 bars, to enable a high lift with homogeneous penetration and distribution of the microcapsule formulation in the textile substrate. In an example of an embodiment, the quantity of formulation impregnated in the textile substrate having a mass per unit area of 50 g/m² may be greater than 50 g/m², particularly between 50 g/m² and 150 g/m².

After impregnation, the textile substrate may be dried, particularly by means of infrared lamps, before the application of ionising radiation on the impregnated textile substrate. The drying also enables heat setting of the microcapsule formulation in the textile substrate. In an alternative embodiment, the heat setting may be performed after the application of the ionising radiation, for example at a temperature between 100 and 140° C., to complete the setting of the microcapsules by means of reactions of the thermally reactive bridging agents.

The power and duration of the radiation are arranged to activate the reactive groups so as to ensure the bridging of the microcapsules on said substrate. According to one embodiment, the ionising radiation is an ion bombardment generated by an electron accelerator, which may be performed in one or two passages, particularly in one passage on either side of the textile substrate. Moreover, the power of the ionising radiation combined with the presence of the various reactive groups makes it possible to fix a large quantity of microcapsules in the textile substrate.

In addition, the reactions between the reactive groups of the envelope and the bridging agents make it possible to bind the envelope of the microcapsules with the fibres, the microcapsules together and, optionally, the bridging agents together, so as to create a solid three-dimensional network resistant to friction and to washing or dry cleaning.

Finally, the textile substrate may be washed and dried or undergo other treatments necessary for the subsequent use thereof.

According to one embodiment, the functionalisation method also comprises a step consisting of preparing a material displaying tightness to the microcapsule formulation and, prior to the impregnation of the textile substrate with the microcapsule formulation, applying the tight material on at least one zone of the surface of the textile substrate so as to prevent the subsequent impregnation of said zone with the microcapsule formulation.

This embodiment makes it possible to enhance the flexibility of the functionalised textile substrate, in that the zones devoid of microcapsules may form preferential folding zones of said substrate. In addition, some zones of the textile substrate do not need to be functionalised. In one example of an embodiment, the application zones of the tight material may form a two-dimensional network on the surface of the textile substrate, for example in the form of discrete zones having a rectangular or other geometry. Advantageous, the application zones of the tight material may form 5% to 40% of the total surface area of the textile substrate.

In addition, after the application of the ionising radiation, at least one part of the tight material may be removed from the surface of the textile substrate so as to form zones devoid of microcapsules. In addition, the removal of the tight material, particularly performed by means of hot washing, makes it possible to remove any quantity of microcapsule formulation not fixed during the application of the ionising radiation. For this purpose, it is possible to envisage at least one agent enhancing the dissolution and subsequent removal of the material, for example titanium dioxide and/or a surfactant sulphonate.

If only part of the tight material is removed from the surface, it is furthermore possible to benefit from the properties of said material remaining, particularly relative to the transfer of heat or to the transfer of moisture between adjacent zones having microcapsules.

According to one embodiment, the tight material is based on at least partially hydrolysed polyvinyl alcohol (PVA) which is dissolved in water, said solution also comprising an anti-adherent agent for the microcapsule formulation. In an alternative embodiment, the tight material may be based on Chitosan or Chitin derivatives. For example, the anti-adherent agent may be a glycerol and the viscosity of the material is envisaged to trap the anti-adherent agent to prevent the migration thereof. In particular, the material may be thixotropic and display a viscosity between 50 and 300 dPA·s so as enable application in paste form with migration via the textile substrate to coat the fibres.

The tight material may be applied by means of serigraphy, followed by at least partial drying of said material before impregnation of the textile substrate with the microcapsule formulation. The quantity of material deposited may be between 5 and 40 g/m².

The implementation of the method described above makes it possible to obtain a textile substrate incorporating more than 10 g/m², particularly more than 40 g/m², of microcapsules containing the active composition, wherein the microcapsules are associated by means of bridging between the envelope thereof and the fibres of said substrate. The heat-regulating textile substrate makes it possible to absorb and restore from 5 to more than 150 J/g of heat energy.

In one example of an embodiment, the textile substrate is based on hydrophilic fibres having a titre less than 4 dtex, so as to promote flexibility and the absorption capacity of the microcapsule formulation.

In particular, the fibres may be based on polyester or polyamide. In an alternative embodiment, it is possible to envisage a mixture of polyester or polyamide fibres and cellulose fibres, particularly cotton or viscose, for example in a proportion by weight of 80%/20%.

The textile substrate may comprise a non-woven lap weighing less than 50 g/m², particularly between 30 and 80 g/m², and less than 0.5 mm thick. The length of the fibres of the lap may be between 30 and 60 mm. The lap may be bound by means of water injection or any other means making it possible to obtain a resistant and absorbent lap (interlocking, chemical binding with suitable binder, thermal binding).

In addition, the textile substrate may undergo, prior to the functionalisation thereof, specific treatments, particularly to enhance the cohesion and/or wettability thereof. Furthermore, according to the envisaged application, the textile substrate may also be formed from a knit or woven fabric.

The textile substrate, when it is functionalised with an active composition comprising a phase change material, makes it possible to perform heat regulation. In particular, as mentioned above, two types of microcapsules may be incorporated in the textile substrate to enhance the heat regulation provided.

The textile substrate may be used to fashion a textile article, particularly for bed linen such as pillows, quilts, or for clothing, particularly for sports or work.

In particular, the textile article may comprise, on one side of a textile substrate, an inner textile layer and, on the other side of said substrate, an outer textile layer which is arranged to capture an air volume, such as a cotton wadding layer. In this way, by arranging the inner layer facing the body, the heat regulation function is optimised. Moreover, the textile article may also comprise a waterproof/breathable layer, for example hydrophilic or porous hydrophobic, which is arranged on the outer textile layer so as to allow the body to breathe by preventing liquid water from reaching same.

1-20. (canceled)

21. A method of firming a textile substrate by means of an active composition, said method comprising the steps of:
preparing a microcapsule formulation containing the active composition in an envelope, said envelope being based on a material comprising a type of reactive group upon an ionising radiation, said formulation also comprising at least one bridging agent having two types of reactive groups upon an ionising radiation;
impregnating the textile substrate with the microcapsule formulation; and
applying ionising radiation on the impregnated textile substrate so as to bridge the microcapsules on said substrate by reacting the reactive groups.

22. The method according to claim 21, wherein said preparing step comprises preparing a microcapsule formulation having between 30% and 60% by weight microcapsules dispersed in at least one solvent.

23. The method according to claim 22, wherein said preparing step further comprises preparing the microcapsule formulation so as to include at least one agent enhancing the stability of the dispersion.

24. The method according to claim 21, wherein said preparing step comprises preparing the microcapsule formulation so as to include a liquefier.

25. The method according to claim 21, wherein said preparing step comprises providing a mass ratio between the bridging agent(s) and the microcapsules of between 0.10 and 0.30.

26. The method according to claim 21, further comprising selecting the reactive groups upon an ionising radiation from the group consisting of hydroxyl, carboxyl, carbonyl, acrylate, methacrylate, amine, amide, imide, urethane, styrene groups.

27. The method according to claim 26, wherein the preparing step comprises preparing a microcapsule formulation comprising a mixture of bridging agents selected from the group consisting of glycidyl acrylate or methacrylate (AGLY or MAGLY), polyethylene glycol 200, 400, 600 diacrylates (PEG200 DA, PEG400 DA, PEG600 DA), dipropylene glycol diacrylate (DPGDA), potassium sulphopropyl methacrylate (SPMK) and lauryl methacrylate or acrylate.

28. The method according to claim 26, further comprising basing the envelope of the microcapsules on polymethylmethacrylate (PMMA).

29. The method according to claim 21, wherein the impregnating step is performed by means of padding, the conditions of said padding and the features of the textile substrate being adapted to lift at least 80% by weight of microcapsule formulation in said textile substrate.

30. The method according to claim 21, further comprising drying the impregnated textile substrate before the application of said ionising radiation.

31. The method according to claim 21, wherein at least some groups are thermally reactive and said method further comprising a heat setting step of the microcapsules by means of a reaction of said groups.

32. The method according to claim 21, wherein the ionising radiation applying step comprises using an electron bombardment.

33. The method according to claim 21, further comprising:
preparing a material displaying tightness to the microcapsule formulation and, prior to the impregnation of the textile substrate with the microcapsule formulation, and
applying the material displaying tightness on at least one zone of a surface of the textile substrate so as to prevent the subsequent impregnation of said at least one zone with the microcapsule formulation.

34. The method according to claim 33, further comprising after the application of the ionising radiation, removing at least one part of the material displaying tightness from the surface of the textile substrate so as to form zones devoid of microcapsules.

35. The according to claim 33, further comprising having the material displaying tightness on at least partially hydrolysed polyvinyl alcohol (PVA) dissolved in water, said solution also comprising an anti-adherent agent for the microcapsule formulation.

36. The method according to claim 33, further comprising applying the material displaying tightness by serigraphy, followed by at least partial drying of said material before impregnation of the textile substrate with the microcapsule formulation.

37. A textile substrate formed using a method according to claim 21, said substrate incorporating more than 10 g/m² of microcapsules containing the active composition, and said microcapsules being associated by means of bridging between the envelope thereof and the fibres of said substrate.

38. The textile substrate according to claim 37, wherein the active composition comprises a phase change material having a melting point arranged to ensure heat regulation.

39. The textile substrate according to claim 38, wherein two types of microcapsules are incorporated, and the phase change materials of each of the types of microcapsules differing by the melting point thereof.

40. A textile article fashioned with the textile substrate according to claim 37, said article also comprising, on one side of the textile substrate, an inner textile layer and, on an other side of said substrate, an outer textile layer which is arranged to capture an air volume.
